(19) United States
(12) Patent Application Publication
(10) Pub. No.: US 2026/0300587 A1
(43) Pub. Date: Oct. 1, 2026

(54) COMPUTER SYSTEM FOR ACCELERATING FLUID SIMULATION THROUGH COLLABORATION BETWEEN DPU AND CPU

(71) Applicant: Zhejiang University, Hangzhou (CN)

(72) Inventors: Yiyi MA, Hangzhou (CN); Zhaolin ZHENG, Hangzhou (CN); Qi ZHANG, Hangzhou (CN); Tuqiao ZHANG, Hangzhou (CN)

(21) Appl. No.: 19/273,268

(22) Filed: Jul. 18, 2025

(30) Foreign Application Priority Data
Mar. 26, 2025 (CN) 202510364416.X

(51) Int. Cl. G06F 30/28; G06F 111/02; G06F 113/08

(52) U.S. Cl. CPC G06F 30/28; G06F 2111/02; G06F 2113/08

(57) ABSTRACT

A computer system for accelerating fluid simulation through collaboration between a data processing unit (DPU) and a central processing unit (CPU) includes one or more computing nodes, where the computing nodes communicate with each other via a network, and each computing node is configured with a same number of CPUs and DPUs. Each computing node is provided with one or more than two CPUs, where the plurality of CPUs communicate with each other via internal connections, and the CPUs are configured to iteratively solve fluid simulation control equations and write iteration results to a memory. Each computing node is provided with one or more than two DPUs, where each DPU uses a direct memory access controller to directly read memory data without passing through a CPU memory controller, to calculate and/or verify whether a residual of the iteration result satisfies a convergence criterion.

### CROSS-REFERENCE TO RELATED APPLICATIONS

The present application claims priority to Chinese Patent Application No. 202510364416. X, filed on Mar. 26, 2025, the entire disclosure of which is incorporated herein by reference.

### TECHNICAL FIELD

The present disclosure relates to the field of large-scale parallel solving in computational fluid dynamics, and in particular to a computer system for accelerating fluid simulation through collaboration between a data processing unit (DPU) and a central processing unit (CPU).

### BACKGROUND

Fluid simulation is a computer-aided technology for simulating fluid flow, and has been widely applied in aerospace, automobile, energy and other fields. In fluid simulation, a central processing unit (CPU) is responsible for executing core computational tasks, and its multi-core processing capabilities and multi-threading characteristics are crucial for dealing with large-scale parallel computing tasks, particularly for fluid dynamics problems involving intensive iterations and complex computations. However, with increasing requirements for complexity and accuracy of simulation models, the demand for computational resources increases dramatically. Improvement of CPU performance is restricted by a lithography process, which slows down development, making it difficult for the CPU to meet the requirements for high-performance fluid simulation.

The performance bottleneck in the fluid simulation is mainly reflected in two aspects: one is floating-point computing performance of the CPU, which is critical for performing numerical calculations; and the other is a memory reading and writing speed, because the fluid simulation requires frequent data reading and writing from a memory. For example, matrix iteration solving is usually limited by the floating-point performance of the CPU, while more of residual computations of physical fields such as a pressure and a flow velocity are limited by the memory reading and writing speed. Different hardware bottlenecks of different algorithms give birth to heterogeneous algorithms with different computing units.

In the prior art, there are various computer systems for accelerating fluid simulation. For example, a computer network system and a computer system are disclosed in the Patent Publication No. CN118714020B. The patent relieves the communication bottleneck between CPUs by optimizing the network topology, which improves parallel computing efficiency, but has a bottleneck in the memory reading and writing speed.

For another example, a parallel algorithm transplantation optimization method based on a domestic accelerator is disclosed in the Patent Publication No. CN118245039B. A parallel algorithm is developed to accelerate fluid simulation through CPU and graphics processing unit (GPU) heterogeneity, which utilizes the floating-point computing performance of a GPU to improve a parallel computing speed, and significantly improves overall computing performance, but still has some defects, such as high hardware cost and difficulty in transplanting the CPU parallel algorithm replication to the GPU.

The two different types of prior art do not solve the bottleneck problem of the memory reading and writing speed in fluid simulation, and the application range is limited.

### SUMMARY

In view of the defects of the prior art, an objective of the present disclosure is to provide a computer system for accelerating fluid simulation through collaboration between a data processing unit (DPU) and a central processing unit (CPU), so as to achieve the effects of increasing the memory access bandwidth, shortening the waiting time of CPU cores, and improving the fluid simulation efficiency.

In order to achieve the above objective, a computer system for accelerating fluid simulation through collaboration between a DPU and a CPU is provided, including one or more computing nodes, where the computing nodes communicate with each other via a network, and each computing node is configured with a same number of CPUs and DPUs.

Each computing node is provided with one or more than two CPUs, a plurality of CPUs communicate with each other via internal connections, and the CPUs are configured to iteratively solve fluid simulation control equations and write iteration results to a memory.

Each computing node is provided with one or more than two DPUs, where each DPU uses a direct memory access controller to directly read memory data without passing through a CPU memory controller, to calculate and/or verify whether a residual of the iteration result satisfies a convergence criterion. When the current iteration result satisfies the convergence criterion, the CPU completes an ongoing process of iterative solving, and the DPU calculates the residual of the iteration result, and then performs post-processing and result output.

Further, the computer system accelerates fluid simulation algorithm solving through collaboration between the DPU and the CPU, and the following steps are included:
S1: distributing a computational domain to each computing node, storing computational domain grids and physical quantities in the memory, and setting initial conditions and boundary conditions of the computational domain through the CPU in each computing node;
S2: performing parallel fluid simulation computation by each computing node according to task allocation, where
advancing time steps from initial conditions or computation results of the previous time step through the CPU, iteratively solving physical quantities in each time step and storing the physical quantities in the memory, and reading boundary conditions and an iteration result in the memory through the DPU to calculate a residual and determine whether the residual satisfies the convergence criterion; reading a convergence determination result of the DPU through the CPU, when the residual fails to satisfy the convergence criterion, continuing the iterative solving through the CPU; when the residual satisfies the convergence criterion, completing the ongoing iterative solving through the CPU, and calculating a residual of the iteration result through the DPU; and
S3: performing post-processing and result output through the DPU, determining whether the time step is a last time step, otherwise, proceeding to a next time step, repeating the steps S2 and S3 in each time step until the last time step is achieved, and writing the physical quantities obtained by solving to a hard disk through the DPU.

Furthermore, the step S1 further includes:
S11: dividing the computational domain into a plurality of blocks with relatively balanced grid numbers according to a grid density and geometric characteristics of the computational domain;
S12: marking units of a plurality of block interfaces to ensure equivalence in computation results of block nodes across different computing nodes during an iterative computation;
S13: configuring a parallel computing environment to ensure that various blocks are independently processed in parallel on different computing nodes, and each computing node has access to physical quantities of computational domains in other computing nodes via a network; and
S14: specifying an initial value for each physical quantity in the computational domain, setting boundary conditions, and applying the boundary conditions to boundary grids of the computational domain.

Further, the step of advancing a time step on the basis of the initial value or the computation result of the previous time step, and performing the parallel fluid simulation computation through the computing node on the basis of the physical quantity in each time step further includes the following steps:
(1) performing iterative solving of a momentum conservation equation and updating a flow velocity Uᵢ through the CPU, calculating a residual of the momentum conservation equation and performing convergence determination through the DPU, performing cyclical repetition until an N^{th} residual calculated by the DPU satisfies the convergence determination criterion, performing an (N+1)^{th} iterative solving to obtain the (N+1)^{th} iteration result and updating the flow velocity Uᵢ for subsequent steps through the CPU, and simultaneously calculating a residual of the (N+1)^{th} iteration result as a final residual record through the DPU; or
when the residual never satisfies the convergence determination criterion and the maximum iteration number is reached, acquiring an iteration result of the maximum iteration number and updating the flow velocity Uj for subsequent steps, and simultaneously calculating a residual of the iteration result of the maximum iteration number through the DPU as a final residual record;
(2) performing iterative solving of a pressure Poisson equation and updating a pressure p through the CPU, calculating a residual of the pressure Poisson equation and performing convergence determination through the DPU, performing cyclical repetition until an N^{th} residual calculated by DPU satisfies the convergence determination criterion, performing an (N+1)^{th} iterative solving to obtain a (N+1)^{th} iteration result and updating the pressure p for subsequent steps through the CPU, and simultaneously calculating a residual of the (N+1)^{th} iteration result through the DPU as a final residual record; or
when the residual never satisfies the convergence determination criterion and the maximum iteration number is reached, acquiring an iteration result of the maximum iteration number and updating the flow velocity Uᵢ for subsequent steps, and simultaneously calculating a residual of the iteration result of the maximum iteration number through the DPU as a final residual record;
(3) correcting the flow velocity Uᵢ by using the pressure p, calculating a residual of a mass conservation equation through the DPU and performing convergence determination, when the convergence determination criterion is not satisfied, returning to the step (1) to continue an iterative computation until a convergence criterion is satisfied or the maximum number of times of inner loops between the step (1) and the step (3) is reached;
(4) solving other physical quantities according to the method of the step (1) corresponding to the equation, and simultaneously solving unsolved physical quantities according to the solved physical quantities until the solving of all the physical quantities is completed; and
(5) after all the physical quantities are solved, calculating a residual of a continuity equation through the DPU according to the solved physical quantities and determining whether the residual satisfies the convergence criterion of an outer loop between the step (1) and the step (5), otherwise, returning to the step (1) to continue iterative computation until the convergence criterion of the outer loop between the step (1) and the step (5) is satisfied or the maximum number of times of the outer loops between the step (1) and the step (5) is reached, and entering the step S3.

Furthermore, the step of post-processing and result output further includes:
after the convergence criterion is satisfied, performing auxiliary computation such as result monitoring and real-time post-processing of simulation computation through the DPU;
initiating a data writing request directly to the CPU memory controller via a DPU direct memory access technology, completing the post-processing, and writing results to the memory; or
writing computation results and post-processing results to the hard disk directly or after compression by using PCIe passthrough technology.

Further, in the step (4), other physical quantities include a turbulent viscosity coefficient vₜ, turbulent kinetic energy k and a specific dissipation rate ω, and the solving step further includes:
[1] performing iterative solving of a turbulent kinetic energy k equation and updating the turbulent kinetic energy k through the CPU, calculating a residual of the momentum conservation equation and performing convergence determination through the DPU, performing cyclical repetition until an N^{th} residual calculated by the DPU satisfies the convergence determination criterion, performing an (N+1)^{th} iterative solving through the CPU, acquiring a (N+1)^{th} iteration result, and updating the turbulent kinetic energy k for subsequent steps; or
when the maximum iteration number is reached, acquiring the iteration result of the maximum iteration number and updating the turbulent kinetic energy k for subsequent steps through the CPU; and
[2] calculating the specific dissipation rate ω through the CPU according to the turbulent kinetic energy k, and further calculating the turbulent viscosity coefficient vₜ.

The present disclosure has the beneficial technical effects and advantages:
1. In the present disclosure, by offloading a residual computation task in fluid simulation to the DPU, the waiting time of CPU cores is effectively shortened, thereby accelerating the fluid simulation computation.
2. An asynchronous parallel method allows the CPU to continue performing an iteration while the DPU calculates the residual, and continue to complete the current iteration after the residual satisfies the convergence criterion, while retaining the computation result. According to experience, adding one iteration further reduces the residual and improves the accuracy.
3. In the present disclosure, the DPU directly initiates the data writing request to the CPU memory controller via the direct memory access (DMA) technology to unload a result output task of the CPU. This process bypasses intervention of the CPU, which allows computational resources and storage resources to be transmitted independently, significantly reducing an I/O burden of the CPU and data transmission delays, thereby accelerating the fluid simulation.
4. The DPU is connected to a mainboard of a computer through a PCIe slot, which is compatible with current common servers and convenient for upgrading existing servers.

### BRIEF DESCRIPTION OF THE DRAWINGS

FIG. 1 is a schematic diagram of a computer system.

FIG. 2 is a schematic diagram of a main process of a method for a computer system for accelerating fluid simulation.

FIG. 3 is a schematic diagram of hardware of a computer system in an example.

FIG. 4 is a schematic diagram of a process of a PIMPLE algorithm for a computer system for accelerating fluid simulation.

Reference numerals in figures: 1. CPU; 2. CPU core; 3. CPU memory controller; 4. PCIe controller; 5. memory; 6. hard disk; 7. DPU; 8. direct memory access controller; 9. network controller; 10. computing node; and 11. DAC high-speed cable.

### DETAILED DESCRIPTIONS OF THE EMBODIMENTS

In order to further illustrate the technical means configured to achieve the intended objectives of the present disclosure and the technical effects of the present disclosure, the particular embodiments, structures and features of the present disclosure, and effects thereof are described in detail hereinafter in conjunction with the accompanying drawings and preferred examples.

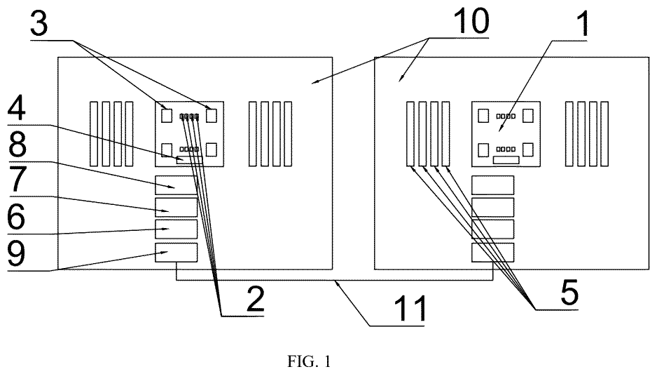

As shown in FIG. 1, the present disclosure provides a computer system for accelerating fluid simulation through collaboration between a data processing unit (DPU) and a central processing unit (CPU), including one or more computing nodes, where the computing nodes communicate with each other via a network, and each computing node is configured with a same number of CPUs and DPUs. Each computing node is provided with one or more than two CPUs, the plurality of CPUs communicate with each other via internal connections, and the CPUs are configured to iteratively solve fluid simulation control equations and write iteration results to a memory. Each computing node is provided with one or more than two DPUs, where each DPU uses a direct memory access controller to directly read memory data without passing through a CPU memory controller, to calculate and/or verify whether a residual of the iteration result satisfies a convergence criterion. When the current iteration result satisfies the convergence criterion, the CPU completes an ongoing process of iterative solving, and the DPU calculates the residual of the iteration result, and performs post-processing and result output.

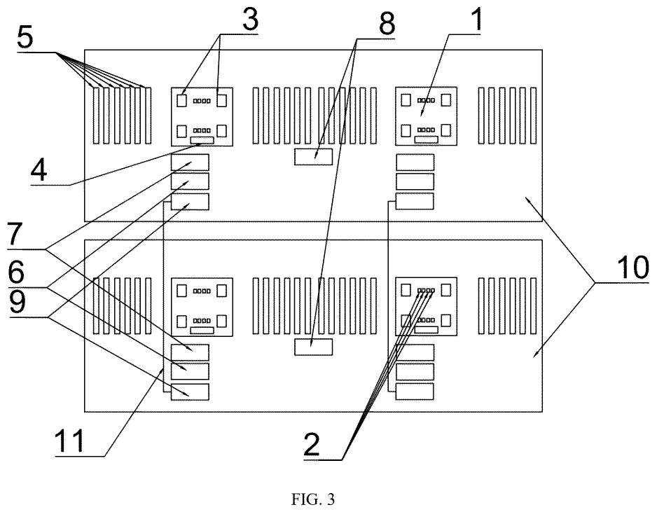

In a particular example, as shown in FIG. 3, the computer system includes 2 ASUS RS720A-E11-RS12 rack servers, and each rack server serves as a computing node. Each computing node includes two AMD 7773X CPUs with integrated memory controllers and PCIe controllers. Each CPU is connected to one DPU and one network controller via the corresponding PCIe controller. A mainboard of each computing node integrates one DMA controller and is connected to one hard disk, each CPU is connected to 12 memories, and the network controllers on the two computing nodes are connected in pairs via DAC high-speed cables.

TABLE 1
Hardware model

| Serial | | | | |
|---|---|---|---|---|
| number | Name | Quantity | Unit | Specification |
| 1 | Server platform | 2 | Piece | ASUS RS720A-E11- |
| | and mainboard | | | RS12 |
| 2 | CPU | 4 | Piece | AMD 7773X |
| 3 | DPU | 4 | Piece | Nvidia Bluefield 2 |
| 4 | Network | 4 | Piece | NVIDIA ConnectX ®- |
| | controller | | | 6 Dx |
| 5 | DMA controller | 2 | Piece | Integrated in mainboard |
| 6 | Memory | 48 | Piece | Omission |
| 7 | Hard disk | 2 | Piece | PCIe 4.0 solid state disk |
| 8 | DAC high-speed | 2 | Piece | 200 GB Infiniband |
| | cable | | | |

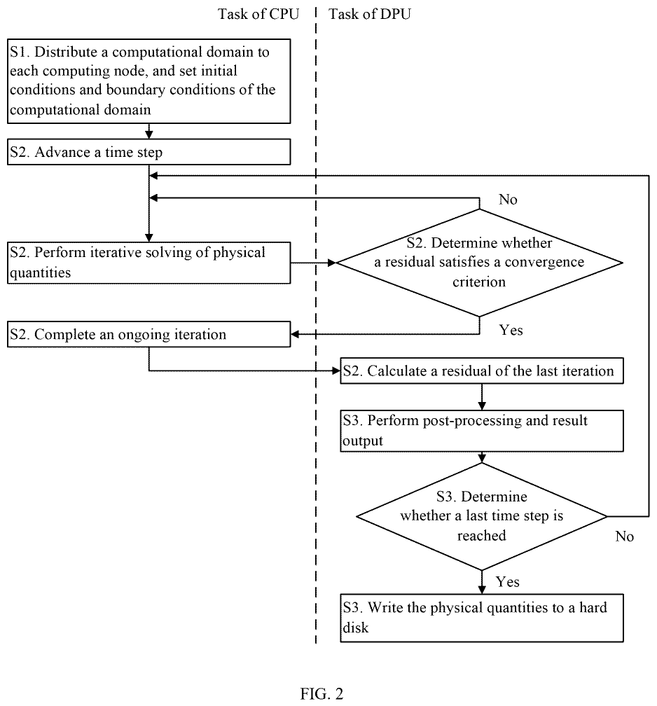

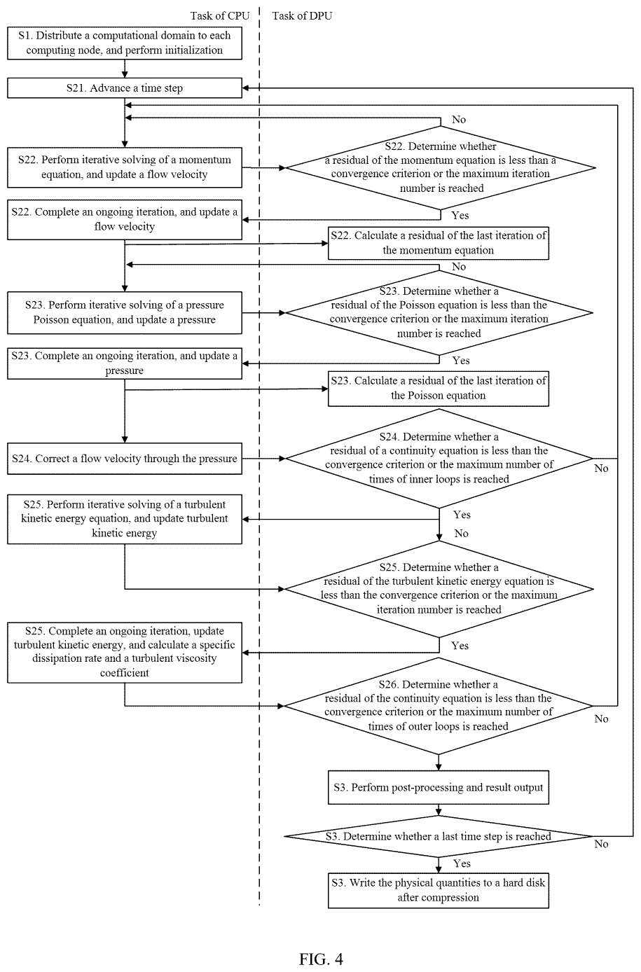

As shown in FIG. 2 and FIG. 4, a method for accelerating a PIMPLE algorithm through collaboration between a DPU and a CPU to perform fluid simulation is provided based on the computer system. The method is based on numerical solving of incompressible flow of the PIMPLE algorithm. The numerical solving of incompressible flow is an important topic in fluid dynamics, and its key algorithm is pressure-velocity coupling, including SIMPLE, PISO and PIMPLE. Among these methods, the PIMPLE method combines iterative correction of SIMPLE and multi-step pressure correction of PISO, which is suitable for solving steady and unsteady incompressible flow with wide adaptability and high solving accuracy. Based on a hardware system of an example, the specific steps are as follows:
S1: A computational domain is distributed to two computing nodes, computational domain grids and physical quantities are stored in memories of the two computing nodes respectively, and the CPU sets initial conditions and boundary conditions of the computational domain. Specific steps are as follows:

According to a grid density and geometric characteristics of the computational domain, the computational domain is divided into 48 blocks. In this example, the number of blocks is equal to the number of memories, and the number of grids of the blocks is relatively balanced, such that computational load balance of each computing node is realized. Units of block interfaces are marked to ensure equivalence in computation results when the block interfaces are iteratively computed at different computing nodes.

A parallel computing environment is configured to ensure that various blocks are independently processed in parallel on different computing nodes, and each computing node has access to physical quantities of computational domains in other computing nodes via the network. An initial value is assigned to each physical quantity in the computational domain, and corresponding boundary conditions are set. The boundary conditions are assigned to the boundary grids with fixed values or gradient values.

S2: The two computing nodes execute parallel fluid simulation computation according to task allocation, and the CPU iteratively solves physical quantities in the computational domain starting from initial conditions or computation results of the previous time step. The physical quantities in this example include a flow velocity Uᵢ, a pressure p, a turbulent viscosity coefficient vₜ, turbulent kinetic energy k and a specific dissipation rate ω, and the above physical quantities are coupled. The present disclosure employs PIMPLE algorithm decoupling to predict, solve and correct the physical quantities sequentially. After each iteration is completed, an iteration result is written to the memory, the DPU reads the boundary conditions in the memory and the iteration result of the physical quantity inside the computational domain, calculates a residual of the physical quantity, and determines whether the residual satisfies a convergence criterion. In this example, the convergence criterion is set to 10⁻⁶. When the DPU calculates the residual, the CPU continues to perform iterative solving, and writes the iteration result to the memory. The CPU reads a convergence determination result of the DPU, when convergence fails, the CPU continues to perform the iterative solving, and when convergence succeeds, the step S3 is started.

Specifically, a time step is advanced on the basis of the initial value or the computation result of the previous time step, and the computing node performs the parallel fluid simulation computation on the basis of the physical quantity in each time step, which includes the following steps:

(1) The CPU performs iterative solving of a momentum conservation equation, and updates a flow velocity Uᵢ. The DPU calculates a residual of the momentum conservation equation and performs convergence determination, and cyclical repetition is performed until an N^{th} residual calculated by the DPU satisfies the convergence determination criterion. The CPU performs an (N+1)^{th} iterative solving to obtain a (N+1)^{th} iteration result and updates the flow velocity Uᵢ for subsequent steps, and simultaneously the DPU calculates a residual of the (N+1)^{th} iteration result as a final residual record. For example, the CPU performs a first iterative solving, then the CPU performs a second iterative solving, and simultaneously, the DPU calculates a residual of the first iterative solving and performs convergence determination. After the DPU determines that the residual of the result of the first iteration satisfies the convergence criterion, the CPU completes the second iteration and takes the result of the second iteration as a final result for subsequent steps, and simultaneously, the DPU calculates a residual of the second iterative solving and directly takes the residual as a final residual record without convergence determination.

Alternatively, when the residual never satisfies the convergence determination criterion and the maximum iteration number is reached, an iteration result of the maximum iteration number is acquired, and the flow velocity Uᵢ is updated for subsequent steps. Simultaneously the DPU calculates a residual of the iteration result of the maximum iteration number as a final residual record.

(2) The CPU performs iterative solving of a pressure Poisson equation and updates a pressure p, the DPU calculates a residual of the pressure Poisson equation and performs convergence determination, and cyclical repetition is performed until the N^{th} residual calculated by DPU satisfies the convergence determination criterion. The CPU performs an (N+1)^{th} iterative solving to obtain a (N+1)^{th} iteration result and updates the pressure p for subsequent steps, and simultaneously, the DPU calculates a residual of the (N+1)^{th} iteration result as a final residual record.

Alternatively, when the residual never satisfies the convergence determination criterion and the maximum iteration number is reached, an iteration result of the maximum iteration number is acquired, and the flow velocity Uᵢ is updated for subsequent steps, and simultaneously, the DPU calculates a residual of the iteration result of the maximum iteration number as a final residual record.

(3) The flow velocity Uᵢ is corrected by using the pressure p, the DPU calculates a residual of a mass conservation equation and performs convergence determination, and when the convergence determination criterion is not satisfied, the step (1) is started to continue an iterative computation until the convergence criterion is satisfied or the maximum number of times (set as 3 times in this example) of inner loops between the step (1) and the step (3) is reached.

(4) Other physical quantities are solved by the method of the step (1) corresponding to the equation, and simultaneously, unsolved physical quantities are solved according to the solved physical quantities until the solving of all the physical quantities is completed. In the step (4), other physical quantities include a turbulent viscosity coefficient vₜ, turbulent kinetic energy k and a specific dissipation rate ω, and the solving step further includes:

[1] The CPU performs iterative solving of a turbulent kinetic energy k equation and updates the turbulent kinetic energy k. The DPU calculates a residual of the momentum conservation equation and performs convergence determination, and cyclical repetition is performed until the N^{th} residual calculated by the DPU satisfies the convergence determination criterion. The CPU performs an (N+1)^{th} iterative solving, acquires a (N+1)^{th} iteration result, and updates the turbulent kinetic energy k for subsequent steps.

Alternatively, when the maximum iteration number is reached, the CPU acquires the iteration result of the maximum iteration number and updates the turbulent kinetic energy k for subsequent steps.

[2] The CPU calculates the specific dissipation rate ω according to the turbulent kinetic energy k, and further calculates the turbulent viscosity coefficient vₜ.

(5) After all the physical quantities are solved, the DPU calculates a residual of a continuity equation according to the solved physical quantities and determines whether the residual satisfies the convergence criterion of an outer loop between the step (1) and the step (5), otherwise, the step (1) is started to continue iterative computation until the convergence criterion of the outer loop between the step (1) and the step (5) is satisfied or the maximum number of times (set as 20 times in this example) of the outer loops between the step (1) and the step (5) is reached, and the step S3 is started.

S3: The DPU performs post-processing and result output, and determines whether the time step is a last time step, otherwise, the next time step is started, the steps S2 and S3 are repeated in each time step until the last time step is achieved, and the DPU writes physical quantities obtained by solving to a hard disk. The step of post-processing and result output further includes:

After the convergence criterion is satisfied, the DPU is configured to perform auxiliary computation such as result monitoring and real-time post-processing of simulation computation. A data writing request is initiated directly to the CPU memory controller via a DPU direct memory access technology, post-processing is completed, and a result is written to the memory. Alternatively, computation results and post-processing results are written to the hard disk directly or after compression by using PCIe passthrough technology.

Specifically, in this example, the DPU outputs numerical computation results of flow fields such as a flow velocity field U, a pressure field p and the turbulent kinetic energy k, and draws contour maps of the flow fields, pressure distribution, turbulent intensities, etc., to evaluate fluid behavior and computational accuracy. The steps S2 and S3 are repeated until the last time step is completed. After the last time step is completed, the DPU compresses the physical quantity, and then writes the physical quantity to the hard disk.

What is claimed is:

1. A computer system for accelerating fluid simulation through collaboration between a data processing unit (DPU) and a central processing unit (CPU), comprising one or more computing nodes, wherein the computing nodes communicate with each other via a network, and each computing node is configured with a same number of CPUs and DPUs;
each computing node is provided with one or more than two CPUs, wherein a plurality of CPUs communicate with each other via internal connections, and the CPUs are configured to iteratively solve fluid simulation control equations and write iteration results to a memory;
each computing node is provided with one or more than two DPUs, wherein each DPU uses a direct memory access controller to directly read memory data without passing through a CPU memory controller, to calculate and/or verify whether a residual of the iteration result satisfies a convergence criterion; and when the current iteration result satisfies the convergence criterion, the CPU completes an ongoing process of iterative solving, and the DPU calculates the residual of the iteration result, and performs post-processing and result output;
the computer system accelerates fluid simulation algorithm solving through collaboration between the DPU and the CPU, and the following steps are comprised:
S1: distributing a computational domain to each computing node, storing computational domain grids and physical quantities in the memory, and setting initial conditions and boundary conditions of the computational domain through the CPU in each computing node;
S2: performing parallel fluid simulation computation by each computing node according to task allocation, wherein
advancing time steps from initial conditions or computation results of the previous time step through the CPU, iteratively solving physical quantities in each time step and storing the physical quantities in the memory, reading boundary conditions and an iteration result in the memory through the DPU to calculate a residual and determine whether the residual satisfies the convergence criterion, and reading a convergence determination result of the DPU through the CPU; when the residual fails to satisfy the convergence criterion, continuing the iterative solving through the CPU; and when the residual satisfies the convergence criterion, completing an ongoing process of iterative solving, and calculating a residual of the iteration result through the DPU; and
S3: performing post-processing and result output through the DPU, determining whether the time step is a last time step, otherwise, proceeding to a next time step, repeating the steps S2 and S3 in each time step until the last time step is achieved, and writing the physical quantities obtained by solving to a hard disk through the DPU.

2. The computer system for accelerating fluid simulation through collaboration between a DPU and a CPU according to claim 1, wherein the step S1 further comprises:
S11: dividing the computational domain into a plurality of blocks with relatively balanced grid numbers according to a grid density and geometric characteristics of the computational domain;
S12: marking units of a plurality of block interfaces to ensure equivalence in computation results of block nodes across different computing nodes during an iterative computation;
S13: configuring a parallel computing environment to ensure that various blocks are independently processed in parallel on different computing nodes, and each computing node has access to physical quantities of computational domains in other computing nodes via a network; and
S14: specifying an initial value for each physical quantity in the computational domain, setting boundary conditions, and applying the boundary conditions to boundary grids of the computational domain.

3. The computer system for accelerating fluid simulation through collaboration between a DPU and a CPU according to claim 2, wherein the step of advancing a time step on the basis of the initial value or the computation result of the previous time step, and performing the parallel fluid simulation computation through the computing node on the basis of the physical quantity in each time step further comprises the following steps:
(1) performing iterative solving of a momentum conservation equation and updating a flow velocity Uᵢ through the CPU, calculating a residual of the momentum conservation equation and performing convergence determination through the DPU, performing cyclical repetition until an N^{th} residual calculated by the DPU satisfies a convergence determination criterion, performing an (N+1)^{th} iterative solving to obtain the (N+1)^{th} iteration result and updating the flow velocity Uᵢ for subsequent steps through the CPU, and simultaneously calculating a residual of the (N+1)^{th} iteration result as a final residual record through the DPU;
alternatively, when the residual never satisfies the convergence determination criterion and a maximum iteration number is reached, acquiring an iteration result of the maximum iteration number and updating the flow velocity Uᵢ for subsequent steps, and simultaneously calculating a residual of the iteration result of the maximum iteration number through the DPU as a final residual record;
(2) performing iterative solving of a pressure Poisson equation and updating a pressure p through the CPU, calculating a residual of the pressure Poisson equation and performing convergence determination through the DPU, performing cyclical repetition until an N^{th} residual calculated by DPU satisfies the convergence determination criterion, performing an (N+1)^{th} iterative solving to obtain an (N+1)^{th} iteration result and updating the pressure p for subsequent steps through the CPU, and simultaneously calculating a residual of the (N+1)^{th} iteration result through the DPU as a final residual record;
alternatively, when the residual never satisfies the convergence determination criterion and the maximum iteration number is reached, acquiring an iteration result of the maximum iteration number and updating the flow velocity Uᵢ for subsequent steps, and simultaneously calculating a residual of the iteration result of the maximum iteration number through the DPU as a final residual record;
(3) correcting the flow velocity Uᵢ by using the pressure p, calculating a residual of a mass conservation equation through the DPU and performing convergence determination, when the convergence determination criterion is not satisfied, returning to the step (1) to continue an iterative computation until the convergence criterion is satisfied or the maximum number of times of inner loops between the step (1) and the step (3) is reached;
(4) solving other physical quantities according to the method of the step (1) corresponding to the equation, and simultaneously solving unsolved physical quantities according to the solved physical quantities until the solving of all the physical quantities is completed; and
(5) after all the physical quantities are solved, calculating a residual of a continuity equation through the DPU according to the solved physical quantities and determining whether the residual satisfies the convergence criterion of an outer loop between the step (1) and the step (5), otherwise, returning to the step (1) to continue iterative computation until the convergence criterion of the outer loop between the step (1) and the step (5) is satisfied or the maximum number of times of the outer loops between the step (1) and the step (5) is reached, and entering the step S3.

4. The computer system for accelerating fluid simulation through collaboration between a DPU and a CPU according to claim 3, wherein of the step of post-processing and result output further comprises:
after the convergence criterion is satisfied, performing auxiliary computation such as result monitoring and real-time post-processing of simulation computation through the DPU;
initiating a data writing request directly to the CPU memory controller via DPU direct memory access technology, completing the post-processing, and writing results to the memory;
alternatively, writing computation results and post-processing results to the hard disk directly or after compression by using PCIe passthrough technology.

5. The computer system for accelerating fluid simulation through collaboration between a DPU and a CPU according to claim 3, wherein in the step (4), other physical quantities comprise a turbulent viscosity coefficient vₜ, turbulent kinetic energy k and a specific dissipation rate ω, and the solving step further comprises:
[1] performing iterative solving of a turbulent kinetic energy k equation and updating the turbulent kinetic energy k through the CPU, calculating a residual of the momentum conservation equation and performing convergence determination through the DPU, performing cyclical repetition until an N^{th} residual calculated by the DPU satisfies the convergence determination criterion, performing an (N+1)^{th} iterative solving through the CPU, acquiring a (N+1)^{th} iteration result, and updating the turbulent kinetic energy k for subsequent steps;
alternatively, when the maximum iteration number is reached, acquiring the iteration result of the maximum iteration number and updating the turbulent kinetic energy k for subsequent steps through the CPU; and
[2] calculating the specific dissipation rate ω through the CPU according to the turbulent kinetic energy k, and further calculating the turbulent viscosity coefficient vₜ.
